(19) United States
(12) Patent Application Publication
(10) Pub. No.: US 2007/0198816 A1
(43) Pub. Date: Aug. 23, 2007

(54) Emulation system for a single-chip multiple-microcontroller and emulation method thereof

(76) Inventor: Chuan-Po Ling, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/270,558

(22) Filed: Nov. 10, 2005

(51) Int. Cl. G06F 9/44

(52) U.S. Cl. 712/227

(57) ABSTRACT

The present invention discloses an emulation system for a single-chip multiple-microcontroller and an emulation method thereof, wherein a multiple-microcontroller emulator comprises: an emulation control logic, at least two microcontrollers, and program counters separately related to the microcontrollers; each program counter corresponds to at least one breakpoint address; every executing program will stop at its corresponding breakpoint address; the status of every microcontroller at the breakpoint addresses is transmitted to a personal computer via the emulation control logic. Thereby, the multiple-microcontroller emulation program in the personal computer can read the execution status of every microcontroller occurring at the breakpoint addresses, and the programmer can obtain the execution status of the multiple-microcontroller emulator in order to develop and debug the program of a single-chip multiple-microcontroller.

### BACKGROUND OF THE INVENTION

1. Field of the Invention

The present invention relates to an emulation system for microcontroller, particularly to an emulation system for a single-chip multi-microcontroller and an emulation method thereof.

2. Description of the Related Art

A microcontroller (microcontroller unit, MCU), which has all the functions of a complete computer, is almost equal to a miniature computer and can work independently without any auxiliary circuit; therefore, a microcontroller is also referred to as a single-chip microcomputer. Microcontrollers are IC (Integrated Circuit) elements primarily used to control the system in various products. The program development of a microcontroller needs an emulation system, wherein breakpoints are used to monitor the execution status of a microcontroller program executed in an emulation system so that the program can be traced and debugged.

As shown in FIG. 1A, a conventional microcontroller emulation system comprises: a personal computer 10, a microcontroller emulator 12 and a test circuit board 14; all those components form an ICE (In-Circuit Emulator). The personal computer 10 has an IDE (Integrated Development Environment) software to be executed. The microcontroller emulator 12 further comprises: an emulation control logic 124; a full duplex connection port interface 122, used for the connection with personal computer 10; a program breakpoint address register 126; and a microcontroller core logic 128, used to replace a physical single-chip microcontroller. The microcontroller emulator 12 can replace the microcontroller on the test circuit board 14. When a programmer is developing the program of a microcontroller, he can preset one or multiple breakpoints on the executed program. When a breakpoint occurs, the microcontroller core logic stops, and the status of the microcontroller core logic 128 can be read out to report the status of program at the breakpoint address, so that it is easier to debug the program and the program developing time can be reduced, too!

Refer to FIG. 1B for another conventional microcontroller emulation system. Herein, in contrast to FIG. 1A, the emulation control logic 124, the program breakpoint address register 126, and the microcontroller core logic 128 are integrated into a dedicated-emulation microcontroller 16. Refer to FIG. 2A for the intra-architecture thereof. Through the full duplex connection port interface 122 and the emulation control logic 124, the programmer uses the IDE software in the personal computer 10 to preset a breakpoint address 164 on the program breakpoint address register 126 to monitor a program counter 162. When the program is executed and program counter 162 is the same as the preset breakpoint address 164, the emulation control logic 124 will stop microcontroller executing; thus, the status of the microcontroller at the breakpoint address 164 can be looked up via the full duplex connection port interface 122 and the emulation control logic 124. Refer to FIG. 2B a diagram showing the conventional emulation system for microcontroller with multiple breakpoint addresses. Herein, the emulation control logic 124 can preset one or multiple breakpoints 164. When the program counter 162 is the same as any one of the preset breakpoint addresses 164, the microcontroller will be stopped at that breakpoint address and the IDE software can read the status of the microcontroller at that breakpoint address. However, the abovementioned method can only apply to the emulation system for microcontroller as there is only one program counter, it will not be applied to multiple-microcontroller (MMCU) which has multiple program counters.

Accordingly, the present invention proposes an emulation system for a single-chip MMCU and an emulation method thereof to overcome the abovementioned problems.

### SUMMARY OF THE INVENTION

The primary objective of the present invention is to provide an emulation system for a single-chip MMCU and an emulation method thereof, wherein an emulation control logic for MMCU is used to enable program counters respectively to correspond to at least one breakpoint address so that a programmer can effectively trace the execution status of every microcontroller in the MMCU emulator.

Another objective of the present invention is to provide an emulation system for a single-chip MMCU and an emulation method thereof, wherein the instructions of each microcontroller can be executed one by one, and the IDE software in the personal computer can instantly reflect the execution status of every microcontroller so that program debugging can be undertaken easily.

Further another objective of the present invention is to provide an emulation system for a single-chip MMCU and an emulation method thereof, wherein the program execution status in the MMCU emulator is read via a personal computer so that the program execution in the single-chip MMCU can be effectively emulated.

To achieve the abovementioned objectives, the present invention proposes an emulation system for a single-chip MMCU and an emulation method thereof, which comprises a MMCU emulator, which further comprises: an emulation control logic and at least two microcontrollers, wherein the emulation control logic can control the operation of every microcontroller, and each microcontroller has an independent program counter, and those microcontrollers respectively execute their programs at separated timings; the IDE (Integrated Development Environment) software in a personal computer can set the breakpoint addresses respectively corresponding to those microcontrollers via a full duplex connection port interface and the emulation control logic; when one program is executed to its preset breakpoint address, i.e. the value of the program counter is identical to the preset breakpoint address, the emulation control logic will stop all the microcontrollers executing, and the IDE software can read the status of every microcontroller occurring at the preset breakpoint address via the emulation control logic and the full duplex connection port interface. The present invention utilizes the emulation control logic to control multiple microcontrollers so that the personal computer end can accurately obtain the execution status of every microcontroller in the MMCU emulator.

The embodiments of the present invention are to be described below in detail in order to enable the objectives, technical contents, characteristics, and accomplishments of the present invention to be more easily understood.

### BRIEF DESCRIPTION OF THE DRAWINGS

FIG. 1A and FIG. 1B are diagrams showing the architectures of conventional microcontroller emulation systems.

FIG. 2A is a block diagram showing the conventional emulation system for a single microcontroller with a single breakpoint address.

FIG. 2B is a block diagram showing the conventional emulation system for a single microcontroller with multiple breakpoint addresses.

FIG. 3 is a diagram showing the architecture of the present invention.

FIG. 4A is a block diagram showing one embodiment of the present invention.

FIG. 4B is a block diagram showing another embodiment of the present invention.

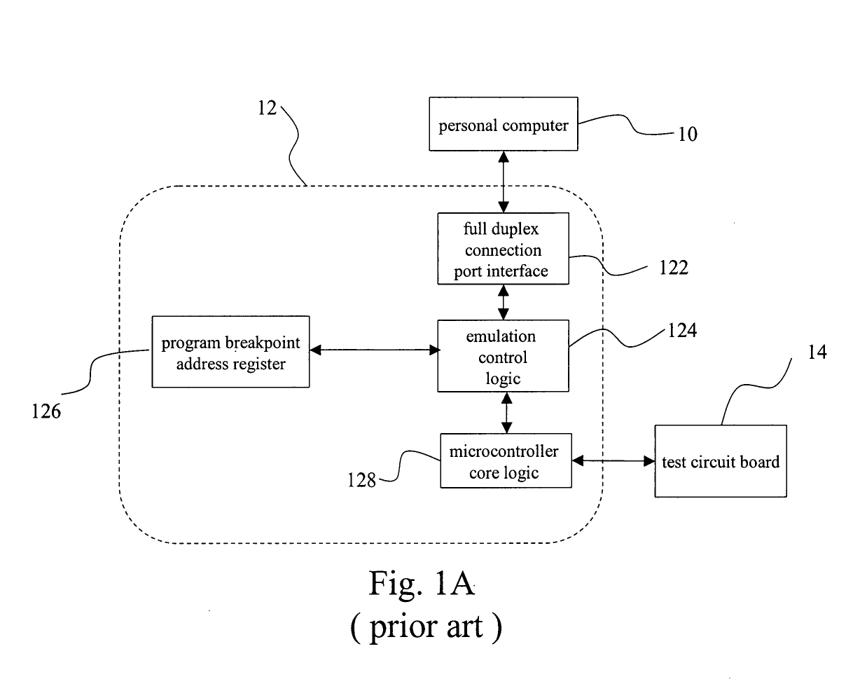

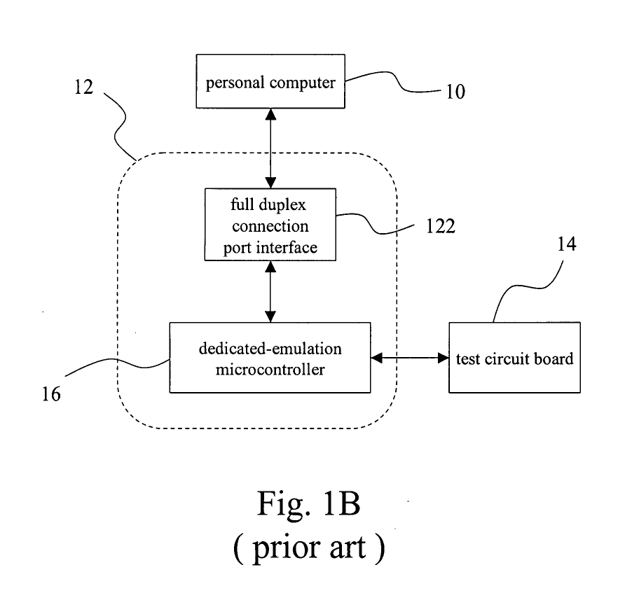

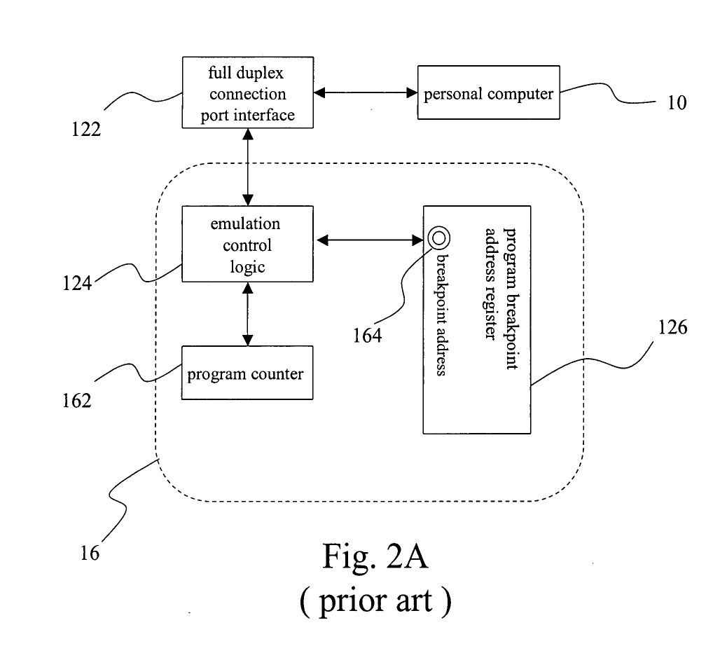

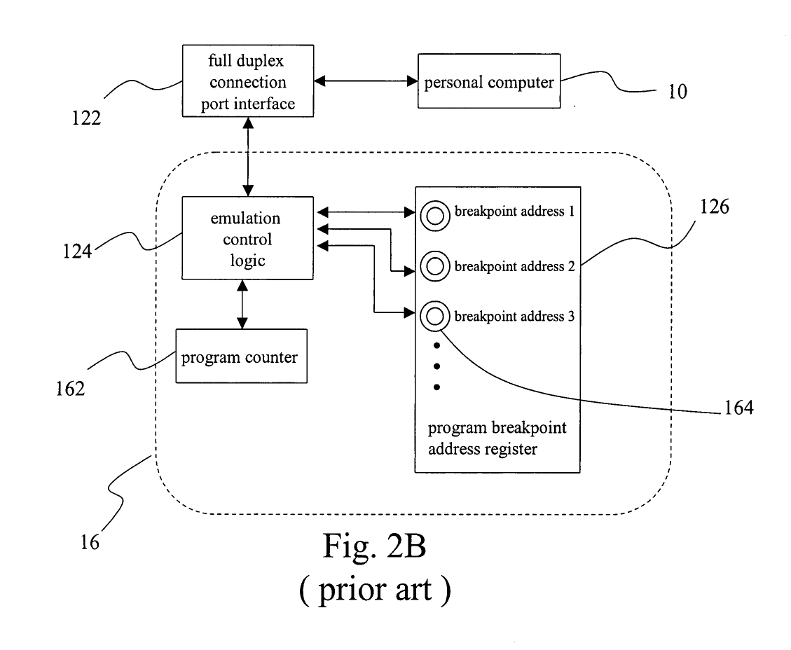

### DETAILED DESCRIPTION OF THE INVENTION

The present invention is to provide an emulation system for a single-chip multi-microcontroller and an emulation method thereof, wherein preset breakpoint addresses are used to trace the program execution statuses of every microcontroller in a MMCU emulator, and the emulation software in the personal computer can read the status of each microcontroller in the MMCU emulator corresponding to the breakpoint address and then informs the programmer all the execution statuses of the MMCU so that the programmer can develop and debug program easily.

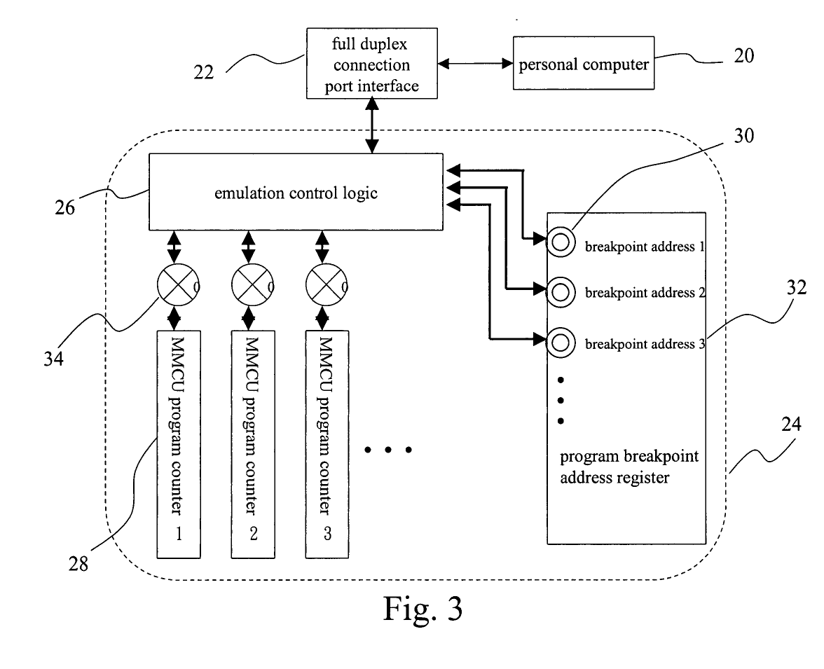

As shown in FIG. 3, the emulation system for a single-chip MMCU in the present invention comprises: a personal computer 20, a full duplex connection port interface 22, and a MMCU emulator 24. The personal computer 20 has an IDE (Integrated Development Environment) software, which is used to develop the programs of the single-chip MMCU in MMCU emulator 24 and debug the programs. The full duplex connection port interface 22 may be a parallel port, a RS-232 interface, a RS-458 interface, a GPIB interface, an IEEE1394 interface, a USB (Universal Serial Bus) interface, an SCSI (Small Computer System Interface) interface, or an Ethernet network. The MMCU emulator 24 is connected to the personal computer 20 via the full duplex connection port interface 22. The MMCU emulator 24 further comprises: an emulation control logic 26, a program breakpoint address register 32 having at least two breakpoint addresses 30 for setting program breakpoints, and MMCU program counters 28, wherein MMCU program counter 1 refers to the program counter of MCU1; MMCU program counter 2 refers to the program counter of MCU2; MMCU program counter 3 refers to the program counter of MCU3, and so on. Each program counter 28 of MMCU can correspond to at least one breakpoint address 30. The programmer can send the MMCU program and commands from the personal computer 20 via the full duplex connection port interface 22 to the MMCU emulator 24. The emulation control logic 26 receives the commands and then enables one or a plurality of breakpoints, which respectively corresponds to one or a plurality of microcontroller program counters 28, via one or a plurality of breakpoint-enabling switches 34. The breakpoint-enabled program counter will be persistently compared with the corresponding breakpoint address 30. When the breakpoint-enabled program counter is the same as the preset breakpoint address, the emulation control logic 26 will stop all the microcontrollers at once. If the breakpoint is not enabled, neither the corresponding program counter is compared with the breakpoint address 30 nor is any microcontroller stopped for that breakpoint. The breakpoint-enabling switch 34 is used to determine whether to enable the comparison of breakpoint address and program counter 28. The emulation control logic 26 can set or clear those breakpoint-enabling switches 34. When one program is executed, the program counter is the same as its corresponding preset breakpoint address 30, the emulation control logic 26 will force all the microcontrollers to stop executing, and send all the statuses in MMCU at that preset breakpoint address 30 to the IDE software in the personal computer 20 via the full duplex connection port interface 22.

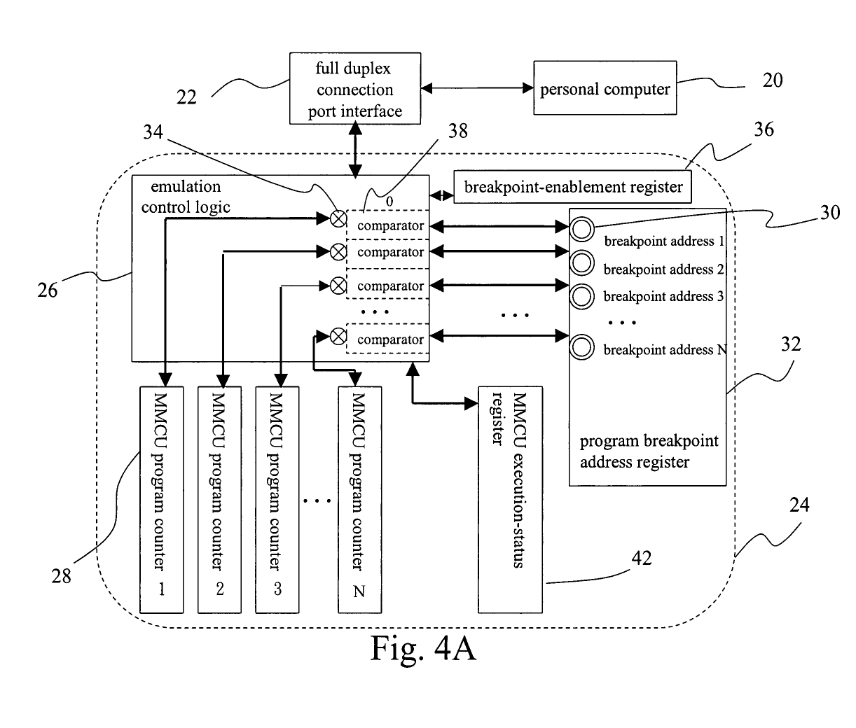

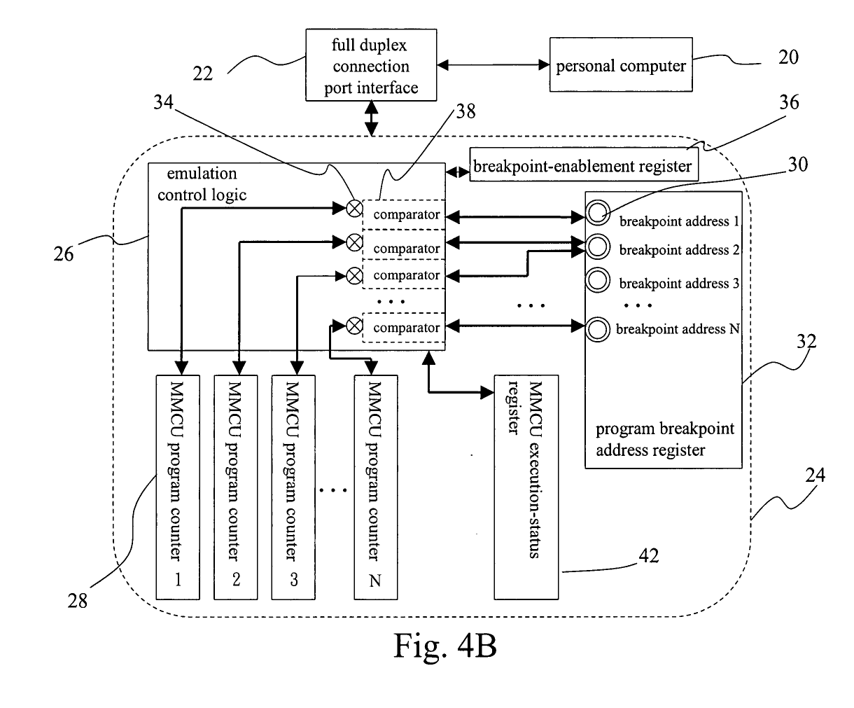

Refer to FIG. 4A for one embodiment of the present invention. When we want the MMCU emulator 24 to stop all the microcontrollers and send back the status at the preset breakpoint address 30, the internal activities thereof is: the IDE software in the personal computer 20 can preset the breakpoint address 30 on a program breakpoint address register 32 for each MCU program via the full duplex connection port interface 22 and the emulation control logic 26; the IDE software also sets the breakpoint-enablement register 36 to define the breakpoint-enabling switches 34 whether to enable or not to enable the corresponding MMCU program counters 28 for those breakpoint addresses 30. When one breakpoint is enabled, comparators 38 will respectively compare the MMCU program counters 28 with their preset breakpoint addresses 30; once one program is executed to its preset breakpoint address 30 and MMCU program counter 28 is identical to its preset breakpoint address 30, the emulation control logic 26 stops all the microcontrollers executing, and the execution statuses of all the microcontrollers will be transmitted to the personal computer 20 via the emulation control logic 26 and the full duplex connection port interface 22. Simultaneously, an MMCU execution-status register 42 records the program execution status of every microcontroller, including the exact MMCU program counter 28 wherein the current breakpoint address 30 occurs, and this information is also transmitted to the personal computer 20 via the emulation control logic 26 and the full duplex connection port interface 22.

Refer to FIG. 4B for another embodiment of the present invention. Herein, in contrast to FIG. 4A, the microcontrollers of the single-chip MMCU respectively execute their programs at separated timings. Each MMCU program counter 28 corresponds to one breakpoint address 30, and more than two MMCU program counters 28 may correspond to an identical breakpoint address 30; for example, both MMCU program counter 2 and MMCU program counter 3 correspond to an identical breakpoint address 2, as shown in the drawing. In the comparator 38, one breakpoint address 30 can be compared with more than two MMCU program counters in order to monitor whether there is an MMCU program counter 28 reaching the preset breakpoint address 30. As the microcontrollers respectively execute their programs at separated timings, the exact MMCU program counter 28, wherein a specific breakpoint address 30 occurs, can be clearly known from the record of the MMCU execution-status register 42, and this information is then transmitted to the personal computer 20 via the emulation control logic 26. Even though two MMCU program counters 28 correspond to an identical breakpoint address 30, they are independent and separate behaviors, and in the same time, there is just only one MMCU program counter 28 that can trigger a breakpoint because the microcontrollers respectively execute their programs at separated timings. Therefore, the case that two MMCU program counters 28 simultaneously trigger the same breakpoint address 30 will never occur.

In summary, the present invention proposes an emulation system for a single-chip MMCU, wherein at least two microcontrollers are installed in the MMCU emulator, and each MMCU program counter corresponds to at least one breakpoint address; when the program is executed to one breakpoint address, the emulation control logic stops all the microcontrollers executing and then transmits the status of every microcontroller at that breakpoint address back to the personal computer for the reference of the programmer. The emulator control logic can effectively monitor the execution status of each microcontroller in the MMCU emulator and can exchange data with the IDE software in the personal computer, and the control parameters thereof can be set via an on-line method. Thereby, the program development and debug of the single-chip microcomputer can be effectively emulated.

Those described above are only the preferred embodiments of the present invention and not intended to limit the scope of the present invention. Any equivalent modification and variation according to the spirit of the present invention is to be included within the scope of the present invention.

What is claimed is:

1. An emulation system for a single-chip multiple-microcontroller, comprising:
a multiple-microcontroller emulator, which further comprises: a emulation control logic and at least two microcontrollers, wherein said emulation control logic can control the operation of each said microcontroller, and each said microcontroller has an independent program counter corresponding to at least one breakpoint address, and when each said program counter is executed to its corresponding breakpoint address, all said microcontrollers are stopped, and at said corresponding breakpoint address, the status of every said microcontroller is transmitted to said emulation control logic; and
a personal computer, communicating with said emulation control logic and obtaining the status of every said microcontroller at said breakpoint addresses via a full duplex connection port interface.

2. The emulation system for a single-chip multiple-microcontroller according to claim 1, wherein said microcontrollers utilize a program breakpoint address register to store breakpoint addresses.

3. The emulation system for a single-chip multiple-microcontroller according to claim 2, wherein each said program counter corresponds to a specific breakpoint address stored in said program breakpoint address register.

4. The emulation system for a single-chip multiple-microcontroller according to claim 1, wherein when each said program counter is executed to its corresponding breakpoint address, all said microcontrollers are stopped, and said emulation control logic transmits the status of every said microcontroller at said corresponding breakpoint address to said personal computer via said full duplex connection port interface.

5. The emulation system for a single-chip multiple-microcontroller according to claim 1, further comprising a multiple-microcontroller execution-status register, wherein when each said program counter is executed to its corresponding breakpoint address, all said microcontrollers are stopped, and said multiple-microcontroller execution-status register sends a message to inform said emulation control logic of the exact program counter wherein said corresponding breakpoint address occurs, and then, said message is transmitted to said personal computer.

6. The emulation system for a single-chip multiple-microcontroller according to claim 1, wherein said emulation control logic can enable the breakpoint of each said program counter via at least one breakpoint-enabling switch.

7. The emulation system for a single-chip multiple-microcontroller according to claim 1, wherein said microcontrollers are respectively executed at separated timings, and an identical breakpoint address can be set to different said program counters.

8. The emulation system for a single-chip multiple-microcontroller according to claim 1, wherein said personal computer has an Integrated Development Environment software for writing and debugging the program in said multiple-microcontroller emulator.

9. The emulation system for a single-chip multiple-microcontroller according to claim 1, wherein said full duplex connection port interface may be a parallel port, a RS-232 interface, a RS-458 interface, a GPIB interface, an IEEE1394 interface, a USB (Universal Serial Bus) interface, an SCSI (Small Computer System Interface) interface, or an Ethernet network.

10. An emulation method utilizing a multiple-microcontroller emulator to execute a breakpoint, comprising the following steps:
connecting a personal computer to an emulation control logic of a multiple-microcontroller emulator via a full duplex connection port interface;
utilizing said emulation control logic to control at least two microcontrollers and to enable at least one breakpoint of program counters of said microcontroller via at least one breakpoint-enabling switch;
stopping all said microcontrollers when each said program counter is executed to its corresponding breakpoint address, and transmitting the status of every said microcontroller at said corresponding breakpoint address to said emulation control logic; and
transmitting the status of every said microcontroller at said corresponding breakpoint address to said personal computer via said full duplex connection port interface.

11. The method according to claim 10, wherein said microcontrollers utilize a program breakpoint address register to store said breakpoint addresses.

12. The method according to claim 10, wherein when each said program counter is executed to its corresponding breakpoint address, all said microcontrollers are stopped, and a message is sent to inform said emulation control logic of the exact program counter wherein said corresponding breakpoint address occurs, and then, said message is transmitted to said personal computer.

13. The method according to claim 10, wherein said emulation control logic sets at least one breakpoint-enabling switch to respectively enable the breakpoints of said microcontrollers.

14. The method according to claim 10, wherein said microcontrollers of said multiple-microcontroller emulator are respectively executed at separated timings, and an identical breakpoint address can be set to different said program counters.

15. The method according to claim 10, wherein said personal computer has an Integrated Development Environment software for writing and debugging the program in said multiple-microcontroller emulator.
